(19) United States
(12) Patent Application Publication
(10) Pub. No.: US 2015/0100189 A1
(43) Pub. Date: Apr. 9, 2015

(54) VEHICLE-TO-INFRASTRUCTURE COMMUNICATION

(71) Applicant: Ford Global Technologies, LLC, Dearborn, MI (US)

(72) Inventors: Levasseur Tellis, Southfield, MI (US); Farid Ahmed-Zaid, Saline, MI (US); Joseph Edward Stinnett, Ypsilanti, MI (US); Christopher Nave, Ypsilanti, MI (US); Thomas Edward Pilutti, Ann Arbor, MI (US); Timothy D. Zwicky, Dearborn, MI (US); James A. Martell, Chesterfield, MI (US); Jerome Charles Ivan, Troy, MI (US)

(73) Assignee: Ford Global Technologies, LLC, Dearborn, MI (US)

(21) Appl. No.: 14/048,003

(22) Filed: Oct. 7, 2013

(51) Int. Cl. B60W 50/00; B60T 7/12

(52) U.S. Cl. CPC B60W 50/00; B60T 7/12
USPC 701/23

(57) ABSTRACT

A vehicle system includes at least one autonomous driving sensor that detects a location of a target vehicle, a communication device that receives infrastructure information from an infrastructure device, and a processing device that controls operation of at least one vehicle subsystem according to the infrastructure information. An exemplary method includes determining a location of a target vehicle, receiving infrastructure information from an infrastructure device, and controlling operation of at least one vehicle subsystem according to the infrastructure information.

### BACKGROUND

Autonomous or partially autonomous vehicles relieve drivers of various driving-related tasks. When operating in autonomous mode, the vehicle can, using on-board sensors, navigate to various locations, which allows the vehicle to travel with minimal, if any, human interaction or in some cases without any passengers. Even when the vehicle is not operating autonomously, autonomous vehicles can help drivers avoid obstacles using data collected from the on-board sensors. Moreover, vehicle-to-vehicle communication further helps autonomous vehicles detect and avoid certain obstacles.

### BRIEF DESCRIPTION OF THE DRAWINGS

FIG. 1 illustrates an exemplary vehicle system for operating a vehicle according to infrastructure information and kinematic data.

FIG. 2 is a flowchart of an exemplary process that may be implemented by the vehicle system of FIG. 1.

FIG. 3 is a schematic diagram illustrating one example of using both vehicle-to-vehicle and vehicle-to-infrastructure communication.

FIG. 4 is a schematic diagram illustrating another example of using both vehicle-to-vehicle and vehicle-to-infrastructure communication.

### DETAILED DESCRIPTION

An exemplary vehicle system includes at least one autonomous driving sensor that detects a location of a target vehicle, a communication device that receives infrastructure information from an infrastructure device, and a processing device that controls operation of at least one vehicle subsystem according to the infrastructure information.

An exemplary method includes determining a location of a target vehicle, receiving infrastructure information from an infrastructure device, and controlling operation of at least one vehicle subsystem according to the infrastructure information.

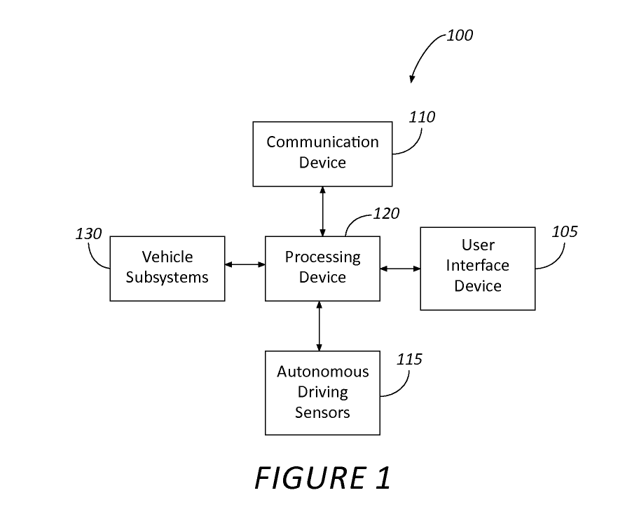

FIG. 1 illustrates an exemplary vehicle system 100 for operating a vehicle according to infrastructure information and kinematic data. The system may take many different forms and include multiple and/or alternate components and facilities. While an exemplary system is shown, the exemplary components illustrated are not intended to be limiting. Indeed, additional or alternative components and/or implementations may be used.

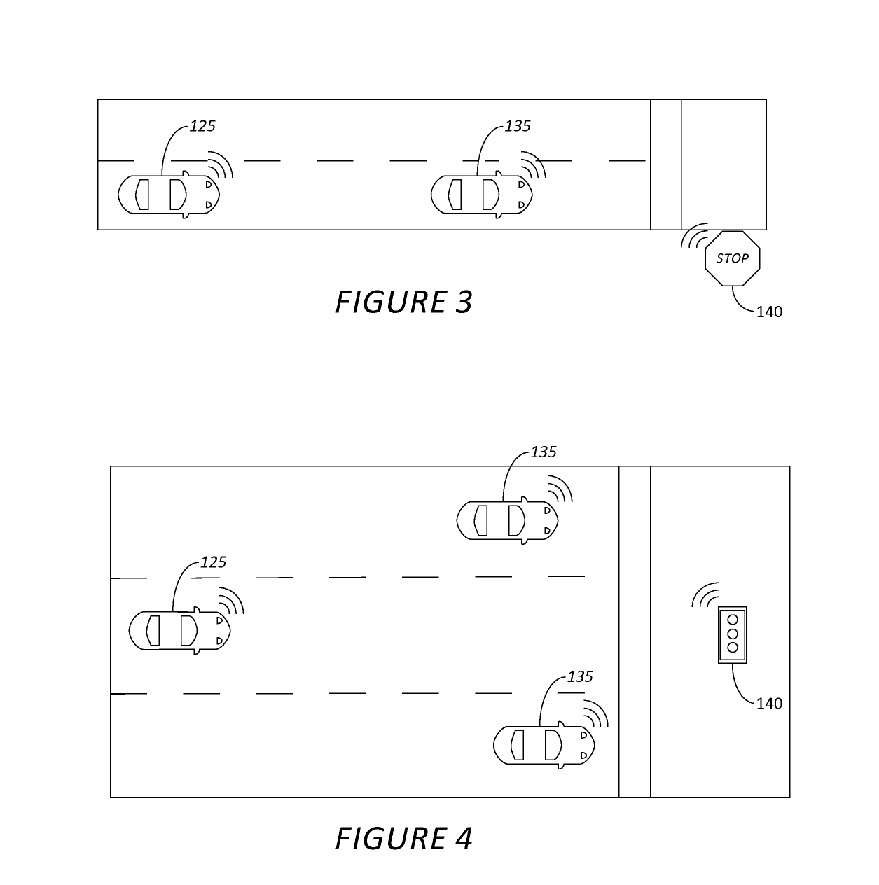

As illustrated in FIG. 1, the system 100 includes a user interface device 105, a communication device 110, autonomous driving sensors 115, and a processing device 120. The system 100 may be incorporated into a vehicle 125 (see FIGS. 3 and 4), such as any passenger or commercial vehicle. Examples of vehicles, therefore, may include a car, a truck, a sport utility vehicle, a taxi, a bus, a train, an airplane, etc.

The user interface device 105 may be configured to present information to a user, such as a driver, during operation of the vehicle 125. Moreover, the user interface device 105 may be configured to receive user inputs. Thus, the user interface device 105 may be located in a passenger compartment of the vehicle 125. In some possible approaches, the user interface device 105 may include a touch-sensitive display screen. The user interface device 105 may further be configured to generate an audible alarm, a visual alarm, or both.

The communication device 110 may be configured to permit communication between two or more vehicles, and in some instances, between the vehicle 125 and an infrastructure device 140 (see FIGS. 3 and 4). Examples of infrastructure devices 140 may include traffic control devices such as traffic lights, stop signs, speed limit signs, parking signs, signs indicating permissible direction of travel (i.e., one-way signs and do-not-enter signs), or the like. Each infrastructure device 140 may be configured to output infrastructure information associated with the infrastructure device 140. Examples of infrastructure information may include a location of the corresponding infrastructure device 140 and/or a status of the corresponding infrastructure device 140. For instance, the infrastructure information may identify the location of a stop sign, stoplight, etc. In some possible approaches, the infrastructure information may define whether the stoplight would give the vehicle 125 right-of-way to enter an intersection. As discussed in greater detail below, some or all of the infrastructure information may come from one or more of the autonomous driving sensors 115.

The communication device 110 may be configured to implement any protocol that allows the vehicle 125 to communicate with other vehicles 125, with infrastructure devices 140, or both. One example protocol may include the Dedicated Short Range Communication (DSRC) protocol. Using the DSRC protocol, the communication device 110 may receive signals representing kinematic data of other nearby vehicles 125 (i.e., target vehicles 135, see FIGS. 3 and 4). The kinematic data may include the speeds of the target vehicles 135, whether any of the target vehicles 135 are decelerating, the rate at which the target vehicles 135 are decelerating, the steering angles of the target vehicles 135, the direction of travel of the target vehicle 135, a path history of the target vehicle 135, etc. The infrastructure information received by the communication device 110 may, as discussed above, represent the location and/or status of the infrastructure device 140.

The autonomous driving sensors 115 may include any number of devices configured to generate signals that help navigate the vehicle 125 while the vehicle 125 is operating in an autonomous (e.g., driverless) mode. Examples of autonomous driving sensors 115 may include a radar sensor, a lidar sensor, a camera, a Global Positioning System (GPS) receiver, or the like. The autonomous driving sensors 115 help the vehicle 125 “see” the roadway and/or negotiate various obstacles while the vehicle 125 is operating in the autonomous mode. Moreover, the autonomous driving sensors 115 may operate when the vehicle 125 is operating in a manual (e.g., an non-autonomous) or partially autonomous mode.

One or more autonomous driving sensor 115 may be configured to collect infrastructure information, kinematic data, or both. For example, one or more autonomous driving sensors 115 may include map data that defines various attributes of a road. Examples of attributes may include stop sign locations, speed limit information, road bifurcations, road curvature, road grade and slope, or the like. The attributes in the map data may correlate to the infrastructure information. Therefore, instead of receiving some or all infrastructure information from infrastructure devices 140, the autonomous driving sensors 115 may retrieve some or all of the infrastructure information from the map data.

The processing device 120 may be configured to control one or more subsystems 130 while the vehicle 125 is operating in the autonomous mode. Examples of subsystems 130 that may be controlled by the processing device 120 may include a brake subsystem, a suspension subsystem, a steering subsystem, and a powertrain subsystem. The processing device 120 may control any one or more of these subsystems 130 by outputting signals to control units associated with these subsystems 130. The processing device 120 may control the subsystems 130 based, at least in part, on signals generated by the autonomous driving sensors 115 as well as signals received from other vehicles 135 (see FIGS. 3 and 4) or an infrastructure device 140 via, e.g., the communication device 110. For example, the processing device 120 may use infrastructure information and/or kinematic data to operate the vehicle 125 in an autonomous mode, to implement a Forward Collision Warning (FCW) system, and/or to implement a Collision Mitigation by Braking (CMbB) system.

In some possible approaches, the processing device 120 may be configured to determine the location of the target vehicle 135, receive infrastructure information and kinematic data, and control the operation of the subsystems 130 accordingly. For instance, in response to kinematic data and infrastructure information that suggests that the target vehicle 135 is stopped at an intersection, the processing device 120 may pre-charge the braking subsystem. In some cases, the processing device 120 may autonomously apply the brakes independent of a user input, meaning that the brakes may be applied even if the vehicle 125 is not otherwise operating in the autonomous mode.

Based on the infrastructure information, the kinematic data, or both, the processing device 120 may predict actions of the target vehicle 135. For example, if the infrastructure information identifies an upcoming traffic light that is red for the target vehicle 135 and the kinematic data indicates that the target vehicle 135 is still moving toward the traffic light, the processing device 120 may predict that the target vehicle 135 will begin to decelerate until stopped so long as the traffic light remains red. If the traffic light turns green, the target vehicle 135 may accelerate. From the infrastructure information and kinematic data, the processing device 120 may predict whether the target vehicle 135 will decelerate at a normal rate, decelerate suddenly due to, e.g., an unexpected obstacle, accelerate, or remain stationary (i.e., at a red light).

In some possible approaches, the processing device 120 may output a warning to the driver or other vehicle occupant via, e.g., the user interface device 105. The warnings may also or alternatively include audible warnings and/or haptic warnings. Moreover, the warning may indicate the direction of the threat. That is, the warning may notify the driver whether the threat is in front of the vehicle 125, behind the vehicle 125, or approaching the vehicle 125 from the side. Other warnings may suggest that the driver assume control of the vehicle 125 (i.e., disable autonomous mode) or suggest that the driver merge to a different lane to, e.g., avoid an upcoming obstacle.

The processing device 120 may determine whether to output the warning based on the infrastructure information, the kinematic data, or both. For example, kinematic data received from one target vehicle 135 via the communication device 110 may indicate that the same or a different target vehicle 135 is stopped in the roadway in the path of the vehicle 125. Alternatively or in addition, the path taken by a target vehicle 135 may suggest an upcoming obstacle if, e.g., the target vehicle 135 swerved aggressively.

The warning output by the processing device 120 may notify the driver of the potential danger caused by the stopped target vehicle 135. Because the communication among vehicles 125 and between vehicles 125 and the infrastructure devices 140 is not limited to line-of-sight, the processing device 120 may use the infrastructure information and kinematic data to warn drivers of potential dangers that are yet unseen to the driver. Moreover, low latency periods in communications among vehicles 125 or between the vehicle 125 and one or more infrastructure devices 140 may provide earlier warnings to the driver.

The processing device 120 may in some circumstances continue to operate the vehicle 125 in an autonomous mode even though a potential danger is detected. The remedial action taken by the processing device 120 may be based on the type of potential danger. For instance, if the processing device 120 determines that the target vehicle 135 suddenly decelerated, the processing device 120 may autonomously apply the braking subsystem to slow or stop the vehicle 125 without any interaction from the driver. In some cases, the processing device 120 may cause the vehicle 125 to stop completely until the obstacle is cleared or until the driver assumes control of the vehicle 125. Alternatively, the processing device 120 may slow the vehicle 125 and navigate around the obstacle.

In general, computing systems and/or devices, such as the processing device 120, may employ any of a number of computer operating systems, including, but by no means limited to, versions and/or varieties of the SYNC® operating system by the Ford Motor Company, the Microsoft Windows® operating system, the Unix operating system (e.g., the Solaris® operating system distributed by Oracle Corporation of Redwood Shores, Calif.), the AIX UNIX operating system distributed by International Business Machines of Armonk, New York, the Linux operating system, the Mac OS X and iOS operating systems distributed by Apple Inc. of Cupertino, Calif., and the Android operating system developed by the Open Handset Alliance.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

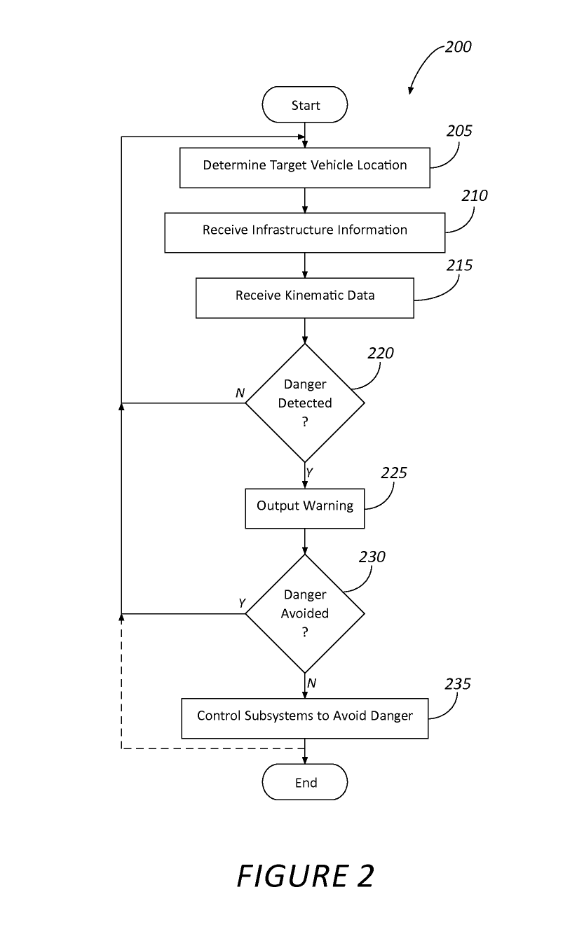

FIG. 2 is a flowchart of an exemplary process 200 that may be implemented by the system 100. Specifically, the process 200 may be implemented on the processing device 120.

At block 205, the processing device 120 may determine a location of the target vehicle 135. The location of the target vehicle 135 may be detected from the autonomous driving sensors 115 and/or kinematic data received from the target vehicle 135 via, e.g., the communication device 110. The location may include an absolute location represented by, e.g., geographic coordinates or a relative location represented by, e.g., a distance from and angle to the vehicle 125.

At block 210, the processing device 120 may receive infrastructure information from an infrastructure device 140, such as a traffic control device. The infrastructure information may define the location of the infrastructure device 140 as well as the state of the infrastructure device 140 (i.e., whether a stop light is green or red relative to the vehicle 125 or the target vehicle 135). Thus, the processing device 120 may determine whether the vehicle 125 and/or the target vehicle 135 has right-of-way to proceed through an intersection based on the state of the infrastructure device 140.

At block 215, the processing device 120 may receive kinematic data from one or more target vehicles 135. The kinematic data may include the speeds of the target vehicles 135, whether any of the target vehicles 135 are decelerating, the rate at which the target vehicles 135 are decelerating, the steering angles of the target vehicles 135, the direction of travel of the target vehicle 135, a path history of the target vehicle 135, etc.

At decision block 220, the processing device 120 may determine whether a danger has been detected based on the infrastructure information and/or the kinematic data. Examples of dangers may include an obstacle in the path of the vehicle 125, a target vehicle 135 improperly proceeding through an intersection, or other situations that may result in a collision. The process 200 may return to block 205 if no danger is detected. When a danger is detected, the process 200 may continue at block 225.

At block 225, the processing device 120 may output a warning to the driver via, e.g., the user interface device 105. The warnings may also or alternatively include audible warnings and/or haptic warnings. Moreover, the warning may indicate the direction of the danger. That is, the warning may notify the driver whether the threat is in front of the vehicle 125, behind the vehicle 125, or approaching the vehicle 125 from the side. Other warnings may suggest that the driver assume control of the vehicle 125 (i.e., disable autonomous mode) or suggest that the driver merge to a different lane to, e.g., avoid an upcoming obstacle.

At decision block 230, the processing device 120 may determine whether the danger has been avoided. For example, the processing device 120 may determine that the danger has been avoided if the obstacle is no longer in the path of the vehicle 125, the vehicle 125 was stopped before a collision, the vehicle 125 was navigated around the obstacle, or the danger was otherwise overcome. If the danger has been avoided, the process 200 may return to block 205. If the danger remains after, e.g., a predetermined amount of time, the process 200 may continue at block 235.

At block 235, the processing device 120 may control the operation of one or more subsystems 130 according to the infrastructure information and the kinematic data to avoid the danger. This may include pre-charging the breaking subsystem, or in some cases, autonomously applying the breaking subsystem independent of any user input to slow or stop the vehicle 125. The processing device 120 may also or alternatively control the steering subsystem to navigate around obstacles in the path of the vehicle 125.

The process 200 may end after block 235 or, in some implementations, return to block 205.

FIGS. 3 and 4 are schematic diagrams illustrating ways the vehicle 125 can use both vehicle-to-vehicle and vehicle-to-infrastructure communication to control the operation of one or more subsystems 130 based at least in part on infrastructure information and kinematic data.

Referring now to FIG. 3, the vehicle 125 may receive kinematic data from the target vehicle 135 and infrastructure information from the infrastructure device 140, which is shown in FIG. 3 as a stop sign. The infrastructure information may identify the location of the stop sign, and the kinematic data may indicate that the target vehicle 135 is decelerating as it approaches the stop sign. The host vehicle 125, therefore, may determine that the target vehicle 135 will be stopped in the path of the host vehicle 125. Thus, the host vehicle 125 may present a warning to the driver to slow the vehicle 125. If the driver does not slow the vehicle 125 within a predetermined distance from the target vehicle 135, or if the host vehicle 125 is operating in an autonomous mode, the processing device 120 of the host vehicle 125 may control one or more subsystems 130 to stop the host vehicle 125 before the host vehicle 125 collides with the target vehicle 135. In some circumstances, the host vehicle 125 may navigate around target vehicles 135 stopped in the path of the host vehicle 125. In the example shown in FIG. 3, however, using infrastructure information such as map data, the host vehicle 125 may recognize that the road has only one lane in each direction and that the host vehicle 125 must stop at the stop sign so navigating around the target vehicle 135 would not be desired.

Referring now to FIG. 4, the infrastructure device 140 is shown as a stoplight, and the state of the traffic light indicates that the host vehicle 125 is not permitted to proceed through the intersection. Kinematic data received at the host vehicle 125 may indicate the presence of target vehicles 135 at the stoplight. The host vehicle 125 may determine that the target vehicles 135 are stopped at the stoplight from the kinematic data. Alternatively, if one or more of the target vehicles 135 are unable to transmit kinematic data, the host vehicle 125 may infer that the target vehicles 135 are stop at the stoplight based on the state of the stoplight. As discussed above, as the host vehicle 125 approaches the stoplight, a warning may be presented to the driver to slow the vehicle 125. If the driver does not slow the vehicle 125 within a predetermined distance from one of the target vehicles 135 or from the stoplight, or if the host vehicle 125 is operating in an autonomous mode, the processing device 120 of the host vehicle 125 may control one or more subsystems 130 to stop the host vehicle 125 before colliding with one of the target vehicles 135 or improperly proceeding through the intersection.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle system comprising:
at least one autonomous driving sensor configured to detect a location of a target vehicle;
a communication device configured to receive infrastructure information from an infrastructure device; and
a processing device configured to control operation of at least one vehicle subsystem according to the infrastructure information.

2. The vehicle system of claim 1, wherein controlling operation of at least one vehicle subsystem includes pre-charging a braking system.

3. The vehicle system of claim 1, wherein controlling operation of at least one vehicle subsystem includes autonomously applying the braking system independent of a user input based at least in part on the infrastructure information.

4. The vehicle system of claim 1, wherein the communication device is configured to receive kinematic data from the target vehicle.

5. The vehicle system of claim 4, wherein the processing device is configured to control the operation of at least one vehicle subsystem according to both the infrastructure information and the kinematic data.

6. The vehicle system of claim 4, wherein the kinematic data includes at least one of a speed of the target vehicle, a deceleration rate of the target vehicle, and a steering angle of the target vehicle.

7. The vehicle system of claim 1, wherein the infrastructure information includes a location of the infrastructure device.

8. The vehicle system of claim 1, wherein the infrastructure information includes a state of the infrastructure device.

9. The vehicle system of claim 8, wherein the state of the infrastructure device indicates whether the target vehicle is permitted to enter an intersection.

10. A method comprising:
determining a location of a target vehicle;
receiving infrastructure information from an infrastructure device; and
controlling operation of at least one vehicle subsystem according to the infrastructure information.

11. The method of claim 10, wherein controlling operation of at least one vehicle subsystem includes pre-charging a braking system.

12. The method of claim 10, wherein controlling operation of at least one vehicle subsystem includes autonomously applying the braking system independent of a user input based at least in part on the infrastructure information.

13. The method of claim 10, further comprising receiving kinematic data from the target vehicle.

14. The method of claim 13, wherein the operation of at least one vehicle subsystem is controlled according to both the infrastructure information and the kinematic data.

15. The method of claim 13, wherein the kinematic data includes at least one of a speed of the target vehicle, a deceleration rate of the target vehicle, and a steering angle of the target vehicle.

16. The method of claim 10, wherein the infrastructure information includes a location of the infrastructure device.

17. The method of claim 10, wherein the infrastructure information includes a state of the infrastructure device.

18. The method of claim 17, wherein the state of the infrastructure device indicates whether the target vehicle is permitted to enter an intersection.

19. A non-transitory computer-readable medium tangibly embodying computer-executable instructions that cause a processor to execute operations comprising:
detecting a location of a target vehicle;
receiving infrastructure information from an infrastructure device;
receiving kinematic data from the target vehicle; and
controlling operation of at least one vehicle subsystem according to the infrastructure information and the kinematic data.

20. The non-transitory computer-readable medium of claim 19, wherein the kinematic data includes at least one of a speed of the target vehicle, a deceleration rate of the target vehicle, and a steering angle of the target vehicle, and wherein the infrastructure information includes a location of the infrastructure device and a state of the infrastructure device indicating whether the target vehicle is permitted to enter an intersection.
